(19) United States
(12) Patent Application Publication
(10) Pub. No.: US 2006/0061834 A1
(43) Pub. Date: Mar. 23, 2006

(54) Image reading apparatus

(76) Inventor: Hirotomo Nonaka, Tokyo (JP)

Correspondence Address: RABIN & Berdo, PC, 1101 14TH STREET, NW, SUITE 500, WASHINGTON, DC, 20005, US

(21) Appl. No.: 11/223,926

(22) Filed: Sep. 13, 2005

(30) Foreign Application Priority Data
Sep. 17, 2004 (JP) JP2004-272084

(51) Int. Cl. H04N 1/04

(52) U.S. Cl. 358/474

(57) ABSTRACT

When a original document platform cover opening/closure detecting unit detects that an original document cover which covers a original document platform has been opened, an image original document has been set, and the original document cover has been closed, it outputs an original document cover closing signal. A preparing operation starting unit starts the operation of an image reading preparing unit after the original document cover closing signal is received. Each time the original document image is read, detected reflection light intensity is converted into image information without being influenced by disturbance light. A change in picture quality of an output image due to an ambient environmental change is prevented.

### BACKGROUND OF THE INVENTION

1. Field of the Invention

The invention relates to an image reading apparatus for reading an original document image by detecting reflection light from an original document.

2. Related Background Art

In an image reading apparatus for reading an original document image by detecting reflection light from an original document, ordinarily, light is irradiated from a predetermined light source to the original document image set onto a original document platform (it also may be called “manuscript platform”) and intensity of the reflection light is detected by a photosensor such as a CCD or the like. However, generally, a photoelectric converting efficiency of the photosensor changes slightly depending on an ambient temperature or the like. Therefore, to reconstruct the original document image by using obtained image information, conversion information to convert the detected reflection light intensity into the image information needs to be corrected each time the original document image is read. To correct the conversion information, image reading preparing means for temporarily reading an image of a black level and an image of a white level just before the original document image is read and automatically correcting the conversion information is added.

For example, when the operator opens a original document platform cover which covers the original document platform in order to set the original document image onto the original document platform, the sensor is made operative and the image reading preparing means automatically starts the operation (refer to JP-A-2001-77990). According to such a technique, since the image reading preparing means starts the operation immediately after the original document platform cover was opened, it is difficult that an influence of the disturbance light caused by the opening of the original document platform cover is eliminated. To solve such a problem, according to JP-A-2001-77990, the conversion information corrected just after the original document platform cover was opened is corrected again at a predetermined time interval. To make such re-correction, a device for firmware is made. Thus, a construction of the firmware becomes complicated.

It is a problem to be solved that, in the conventional technique, the construction of the firmware becomes complicated in order to eliminate the influence of the disturbance light.

### SUMMARY OF THE INVENTION

According to the invention, image reading apparatus for reading an original document image by detecting reflection light from an original document is provided.

There is provided an image reading apparatus comprising:

a light source which irradiates an original document image set on a original document platform;

an image reading unit which detects reflection light of the original document image obtained by the irradiation of the light source and converts it into image information on the basis of predetermined conversion information; and

image reading preparing means which corrects the conversion information,

wherein the apparatus further has

a original document platform cover opening/closure detecting unit which detects opening/closure of an original document cover which covers the original document platform and

preparing operation starting means which starts the operation of the image reading preparing means after it receives an original document cover closing signal from the original document platform cover opening/closure detecting unit.

Further, there is also provided an image reading apparatus comprising:

a light source which irradiates a set original document image;

an image reading unit which detects reflection light of the original document image obtained by the irradiation of the light source and converts it into image information on the basis of predetermined conversion information; and

image reading preparing means which corrects the conversion information,

wherein the apparatus further has

an original document conveying unit which conveys the original document image to a predetermined position when the original document image is set and

preparing operation starting means which starts the operation of the image reading preparing means after the original document image is conveyed to the predetermined position.

In these image reading apparatuses, the image reading preparing means has a function of correcting the conversion information by using a light intensity level of at least either white level reflection light or black level reflection light detected by the image reading unit as a reference.

Moreover, these image reading apparatuses may further comprise a timer means which ignores the operation of the original document platform cover opening/closure detecting unit within a predetermined time after the correction of the conversion information.

Furthermore, there is also provided an image reading apparatus comprising:

a light source which irradiates a set original document image;

an image reading unit which detects reflection light of the original document image obtained by the irradiation of the light source and converts it into image information on the basis of predetermined conversion information; and

image reading preparing means which corrects the conversion information,

wherein the apparatus further has

discriminating means which discriminates whether or not an original document has been set to a predetermined position and

preparing operation starting means which starts the operation of the image reading preparing means after it is determined that the original document has been set to the predetermined position.

Since the image reading preparing means starts the operation after the original document platform cover was closed, such an effect that the influence of the disturbance light is eliminated is obtained.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

FIG. 1 is a constructional diagram of an image reading apparatus of the embodiment 1;

FIG. 2 is a schematic perspective view of the image reading apparatus;

FIG. 3 is an explanatory diagram of a original document platform cover opening/closure detecting unit;

FIG. 4 is a function explanatory diagram (part 1) of an image reading unit;

FIG. 5 is a flowchart for the image reading preparing operation;

FIG. 6 is a flowchart after the end of the real image reading operation;

FIG. 7 is a flowchart after the end of the image reading preparing operation;

FIG. 8 is a constructional diagram of an image reading apparatus of the embodiment 2;

FIG. 9 is a function explanatory diagram (part 2) of an image reading unit;

FIG. 10 is a flowchart for the reverse surface image reading preparing operation; and

FIG. 11 is a block diagram of image reading preparing means according to the invention.

### DETAILED DESCRIPTION OF THE PREFERRED EMBODIMENTS

In an image reading apparatus according to the invention, the above problems are solved merely by changing a control program of a conventional medium conveying apparatus.

### Embodiment 1

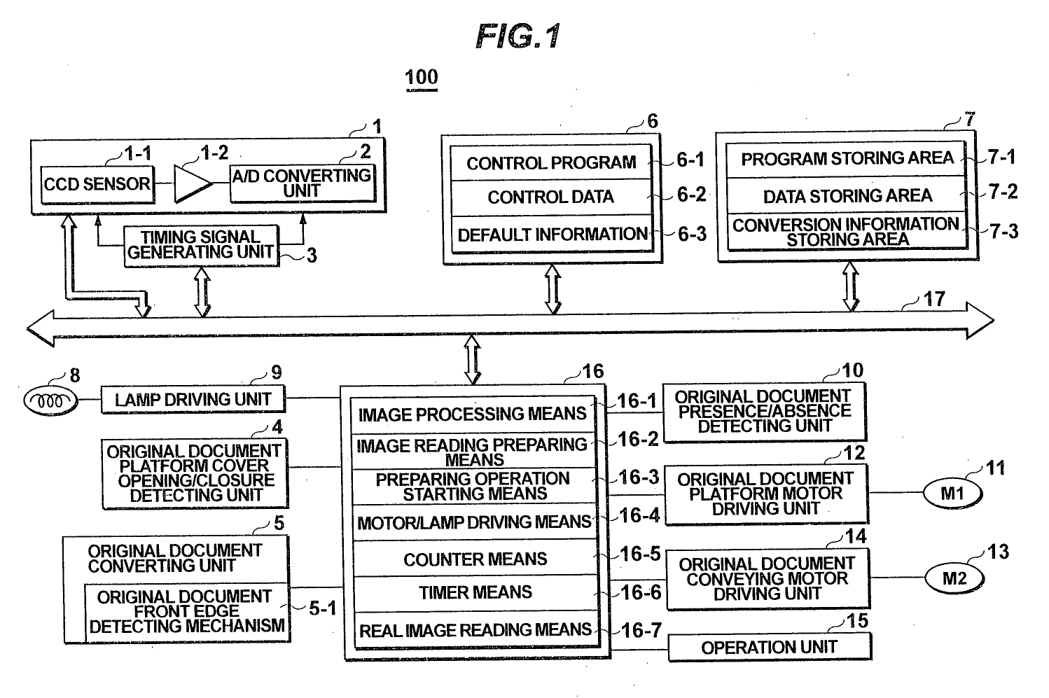

FIG. 1 is a constructional diagram of an image reading apparatus of the embodiment 1.

As shown in the diagram, an image reading apparatus 100 of the embodiment 1 has: an image reading unit 1; an A/D converting unit 2; a timing signal generating unit 3; a original document platform cover opening/closure detecting unit 4; an original document conveying unit 5; a main storing unit 6; a sub-storing unit 7; a lamp 8; a lamp driving unit 9; an original document presence/absence detecting unit 10; aboriginal document platform motor 11; a original document platform motor driving unit 12; an original document conveying motor 13; an original document conveying motor driving unit 14; an operation unit 15; and a control unit 16.

The image reading unit 1 has therein a CCD sensor 1-1 and an amplifier 1-2 and is a portion for detecting reflection light of an original document image obtained by irradiation by the lamp 8 and converting reflection light intensity (lux) into image information (volt) under the control of the control unit 16. That is, the image reading unit 1 is a portion in which the reflection light intensity (lux) detected by the CCD sensor 1-1 is amplified by the amplifier 1-2 under the control of the control unit 16 and outputted as image information (volt).

The A/D converting unit 2 is an analog/digital (A/D) converter for converting the image information in an analog state received from the image reading unit 1 into the image information in a digital state.

The timing signal generating unit 3 is a portion for generating a sync signal under the control of the control unit 16 and supplying it to both of the image reading unit 1 and the A/D converting unit 2 in order to make timing for obtaining the image information of the image reading unit 1 and timing for the analog/digital conversion in the A/D converting unit 2 coincide.

The original document platform cover opening/closure detecting unit 4 is a magnetic sensor (an example) for detecting opening or closure of an original document cover (that is, original document platform cover, which will be explained hereinafter) which covers a original document platform (it also may be called “manuscript platform”). When the original document cover is opened once and subsequently closed, the original document platform cover opening/closure detecting unit 4 outputs an original document cover closing signal to the control unit 16.

The original document conveying unit 5 is a portion for conveying the original document image to a predetermined position (setting position) when the original document image is set into the image reading apparatus 100 by the operator. The original document conveying unit 5 has therein an original document front edge detecting mechanism 5-1 to detect a front edge of the original document image.

The main storing unit 6 is a memory for storing information necessary for the control unit 16 to control the image reading apparatus 100. A control program 6-1, control data 6-2, default information 6-3, and the like have previously been stored in the main storing unit 6.

The sub-storing unit 7 is a memory for the control unit 16 to temporarily store the necessary control program and control data in the step of controlling the image reading apparatus 100. The sub-storing unit 7 has therein: a program storing area 7-1 to temporarily store the control program; a data storing area 7-2 to temporarily store the control data; and a conversion information storing area 7-3 to temporarily store the conversion information (which will be explained hereinafter).

The lamp 8 is a light source for irradiating the original document image set onto the original document platform.

The lamp driving unit 9 is a power supplying circuit for supplying a driving electric power to the lamp 8.

The original document presence/absence detecting unit 10 is a sensor for detecting the presence or absence of the original document set on a platen glass (which will be explained hereinafter).

The original document platform motor 11 is a motor for moving an image reading sensor module (which will be explained hereinafter) including the lamp 8, the CCD sensor 1-1, and the like under the control of the control unit 16.

The original document platform motor driving unit 12 is a power supplying circuit for supplying a driving electric power to the original document platform motor 11.

The original document conveying motor 13 is a motor for conveying the original document image set into the original document conveying unit 5 under the control of the control unit 16.

The original document conveying motor driving unit 14 is a power supplying circuit for supplying a driving electric power to the original document conveying motor 13.

The operation unit 15 is a portion for playing a role of a man-machine interface between the operator and the image reading apparatus 100. The operation unit 15 has: a start button and a copy button which are pressed by the operator; a display for displaying control information; and the like.

The control unit 16 is a CPU (central processing unit) for controlling the whole image reading apparatus 100. In the invention, particularly, the control unit 16 is a portion constructing control means such as image processing means 16-1, image reading preparing means 16-2, preparing operation starting means 16-3, motor/lamp driving means 16-4, counter means 16-5, timer means 16-6, real image reading means 16-7, and the like by executing predetermined programs.

The image processing means 16-1 is a portion for converting the image information received from the image reading unit 1 into image data which can be printed by a predetermined image forming apparatus (not shown) connected to the image reading apparatus 100. This means is control means constructed by a method whereby the CPU reads out a predetermined control program which has previously been stored in the main storing unit 6, stores it into the program storing area 7-1 of the sub-storing unit 7, and executes it in accordance with a predetermined procedure.

The image reading preparing means 16-2 is means for executing a preparation item (for example, an amplification factor of the amplifier 1-2 is set) necessary for the image reading unit 1 to convert the reflection light intensity (lux) detected from the original document image set to a predetermined position on the original document platform into the image information (volt). The image reading preparing means 16-2 is also means for correcting predetermined conversion information. That is, the image reading preparing means 16-2 is means for correcting it so that reference white level reflection light intensity (lux) and reference black level reflection light intensity (lux) detected by the CCD sensor 1-1 are always converted into predetermined voltage levels irrespective of an ambient environment at a point of time of reading the original document image. The contents of such a correcting operation and the predetermined conversion information will be described again in detail hereinafter. This means is control means constructed by a method whereby the CPU reads out a predetermined control program which has previously been stored in the main storing unit 6, stores it into the program storing area 7-1 of the sub-storing unit 7, and executes it in accordance with a predetermined procedure.

The preparing operation starting means 16-3 is means for starting the operation of the image reading preparing means 16-2 after it received the original document cover closing signal from the original document platform cover opening/closure detecting unit 4. This means is control means constructed by a method whereby the CPU reads out a predetermined control program which has previously been stored in the main storing unit 6, stores it into the program storing area 7-1 of the sub-storing unit 7, and executes it in accordance with a predetermined procedure.

The motor/lamp driving means 16-4 is means for driving the lamp-driving unit 9, lighting on the lamp 8, and irradiating the original document image. The motor/lamp driving means 16-4 is also means for driving the original document platform motor driving unit 12, rotating the original document platform motor, and moving the image reading sensor module (which will be explained hereinafter) including the lamp 8, the CCD sensor 1-1, and the like. Further, the motor/lamp driving means 16-4 is means for driving the original document conveying motor driving unit 14, rotating the original document conveying motor, and conveying the original document image set into the original document conveying unit 5 to a predetermined position (setting position). Those means are control means constructed by a method whereby the CPU reads out a predetermined control program which has previously been stored in the main storing unit 6, stores it into the program storing area 7-1 of the sub-storing unit 7, and executes it in accordance with a predetermined procedure.

The counter means 16-5 is means for counting a predetermined numerical value (for example, a rotational amount of the motor, or the like) by a method whereby the CPU controls a counter built therein. This means is control means constructed by a method whereby the CPU reads out a predetermined control program which has previously been stored in the main storing unit 6, stores it into the program storing area 7-1 of the sub-storing unit 7, and executes it in accordance with a predetermined procedure.

The timer means 16-6 is means for counting a predetermined time by a method whereby the CPU controls a timer built therein. This means is control means constructed by a method whereby the CPU reads out a predetermined control program which has previously been stored in the main storing unit 6, stores it into the program storing area 7-1 of the sub-storing unit 7, and executes it in accordance with a predetermined procedure.

The real image reading means 16-7 is means for reading a real image of the original document image while moving the image reading unit 1 in the sub-scanning direction line by line after the end of the image reading preparation. This means is control means constructed by a method whereby the CPU reads out a predetermined control program which has previously been stored in the main storing unit 6, stores it into the program storing area 7-1 of the sub-storing unit 7, and executes it in accordance with a predetermined procedure.

A bus 17 is a signal line for connecting each of the above component portions.

An outline of a mechanism portion of the image reading apparatus to which the invention is applied will now be described by limiting only to portions which will be necessary in the explanation of the invention.

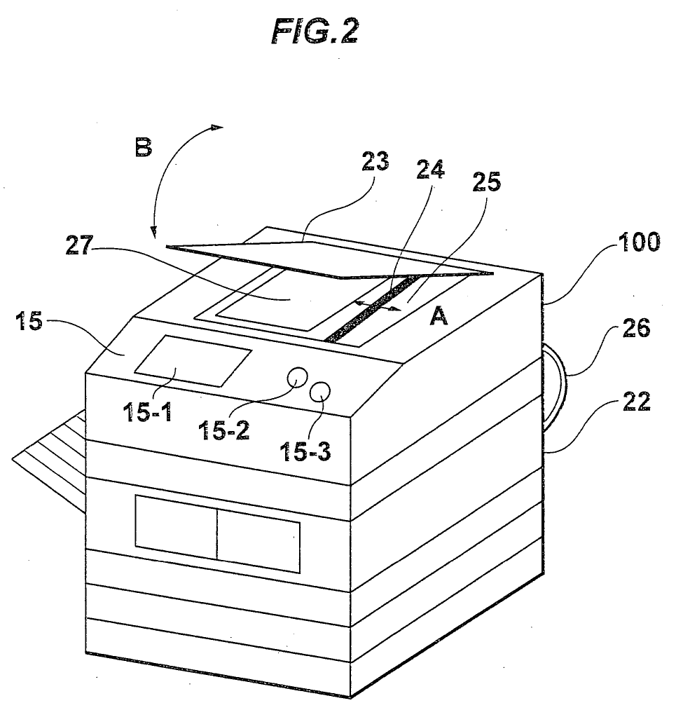

FIG. 2 is a schematic perspective view of the image reading apparatus.

In the diagram, reference numeral 100 denotes the image reading apparatus to which the invention is applied and 22 indicates an image forming apparatus for receiving the image data processed by the image processing means 16-1 (FIG. 1) and outputting an image. The image reading apparatus 100 and the image forming apparatus are electrically connected by a signal cable 26.

In the image reading apparatus 100, reference numeral 27 denotes an original document image; 25 a platen glass for supporting the original document image 27; and 24 an image reading sensor module. When the image is read, the image reading sensor module 24 moves in the directions shown by arrows A, thereby enabling image information to be obtained from the original document image 27. Reference numeral 23 denotes an original document cover (that is, original document platform cover) which can be opened and closed in the directions shown by arrows B. The original document cover 23 can press the original document image 27 onto the platen glass 25 and shield it against disturbance light when the image is read. Reference numeral 15 denotes the operation unit in which a display 15-1, a start button 15-2, and a copy button 15-3 are arranged.

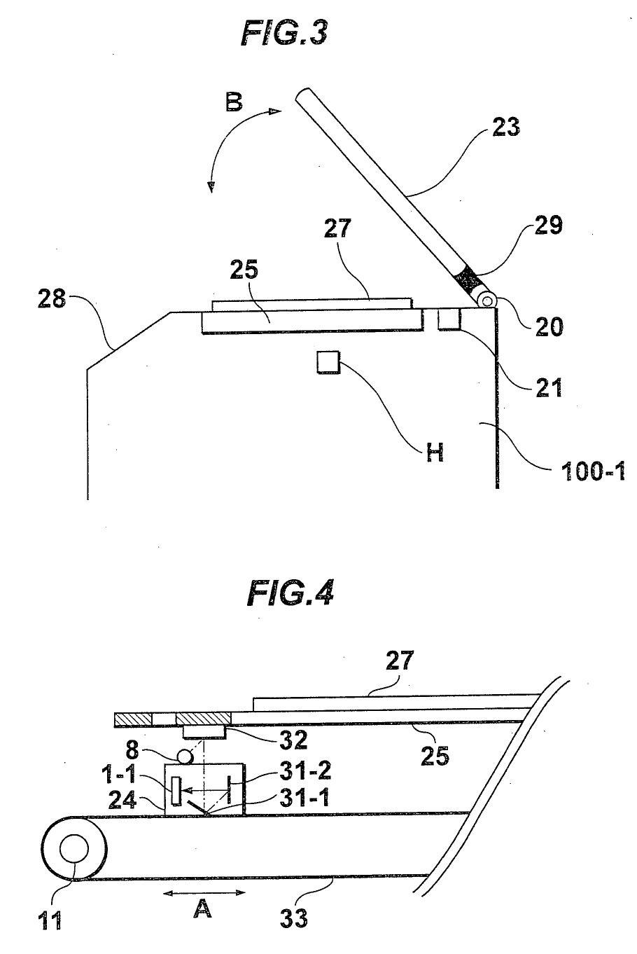

FIG. 3 is an explanatory diagram of a original document platform cover opening/closure detecting unit.

This diagram is a cross sectional view showing an internal construction of the image reading apparatus 100 according to the embodiment 1. In the diagram, reference numeral 25 denotes the platen glass and 23 indicates the original document cover. The original document cover 23 has been attached to an image reading apparatus main body 100-1 so as to be rotatable in the directions of the arrows B through a hinge 20. In order to detect the opening/closure of the original document cover 23, a magnet 29 is attached to the original document cover 23 and a magnetic sensor 21 is attached to the image reading apparatus main body 100-1.

For example, a Hall element is preferably used as a magnetic sensor 21. According to the Hall element, since a voltage to be outputted changes in accordance with a magnitude of a magnetic force, by detecting the magnitude of the magnetic force of the magnet 29, relative positions of the magnetic sensor 21 and the magnet 29 can be detected. Specifically speaking, when the cover 23 is closed, the magnetic force detected by the magnetic sensor 21 is maximum. However, when the cover 23 is opened, the magnetic force which is detected by the magnetic sensor 21 decreases. Therefore, whether the cover 23 is in the open state or the closing state can be detected.

FIG. 4 is a function explanatory diagram (part 1) of the image reading unit.

This diagram is a cross sectional view showing the internal construction of the image reading apparatus 100 according to the embodiment 1. In the diagram, reference numeral 25 denotes the platen glass; 27 the original document image; 8 the lamp for irradiating the original document; and 1-1 the CCD sensor for detecting the reflection light from the original document image 27 irradiated by the lamp 8. In the ordinary standby mode, the lamp 8 is held in the light-on state. Reference numerals 31-1 and 31-2 denote mirrors for guiding the reflection light to the CCD sensor 1-1. The foregoing image reading sensor module 24 is constructed by the lamp 8, mirrors 31-1 and 31-2, and CCD sensor 1-1.

Since the image reading sensor module 24 is fixed to a conveying belt 33 and can be moved in the directions of the arrows A by driving the original document platform motor 11, the CCD sensor 1-1 can obtain the image information from the original document image 27. An outline (one example) of a converting method of converting the reflection light intensity (lux) from the original document image into the image information (volt) and its calibrating method (correcting method) will now be described. The converting method and the calibrating method correspond to the operation of the foregoing image reading preparing means 16-2 (FIG. 1).

In the diagram, reference numeral 32 denotes a standard white board having a predetermined reflectance on the whole surface. Light non-reflective areas are provided for both end portions in the main scanning direction of the standard white board 32. The image reading sensor module 24 is moved in the sub-scanning direction to the position where it faces the standard white board 32 and the image reading position of the CCD sensor 1-1 is swept in the main scanning direction, thereby obtaining reflection light intensity (lux) of the reference black level reflection light (light non-reflective area) and reflection light intensity (lux) of the reference white level reflection light (standard white board). Values of the obtained reflection light intensity (lux) are outputted as image information (volt) of the image reading unit 1 (FIG. 1) at that point of time. Those output voltages are stored as conversion information (volt) into the conversion information storing area 7-3 (FIG. 1) of the sub-storing unit 7 (FIG. 1).

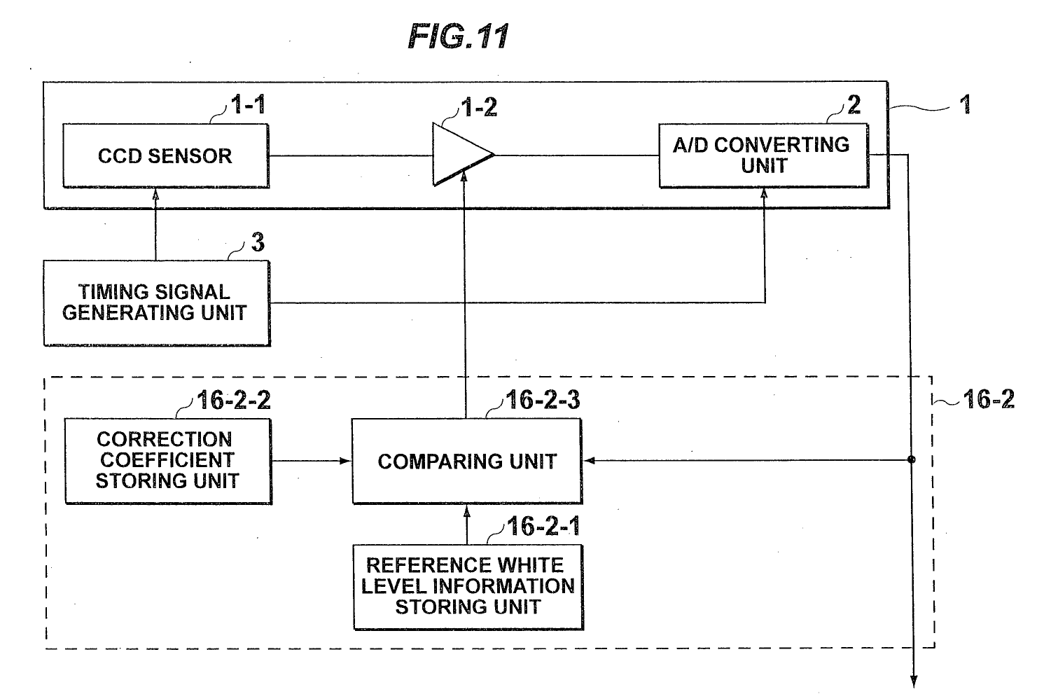

Subsequently, as shown in FIG. 11, the image reading preparing means 16-2 (FIG. 1) has a comparing unit 16-2-3 for comparing the conversion information (volt) of the A/D converting unit 2 with the predetermined image information (volt) showing the reference white level reflection light stored in a reference white level information storing unit 16-2-1 and multiplying a difference between them by a predetermined correction coefficient (x dynamic range) stored in a correction coefficient storing unit 16-2-2, thereby increasing or decreasing the amplification factor of the amplifier 1-2. The image information (volt) which is outputted by the image reading unit 1 at this point of time is made to coincide with the predetermined image information (volt) showing the reference white level reflection light. In this manner, the image reading-preparation for converting the reflection light intensity (lux) detected from the original document image set to the predetermined-position of the original document platform into the image information (volt) is completed.

The operation of the image reading apparatus according to the embodiment 1 will now be described with reference to a flowchart.

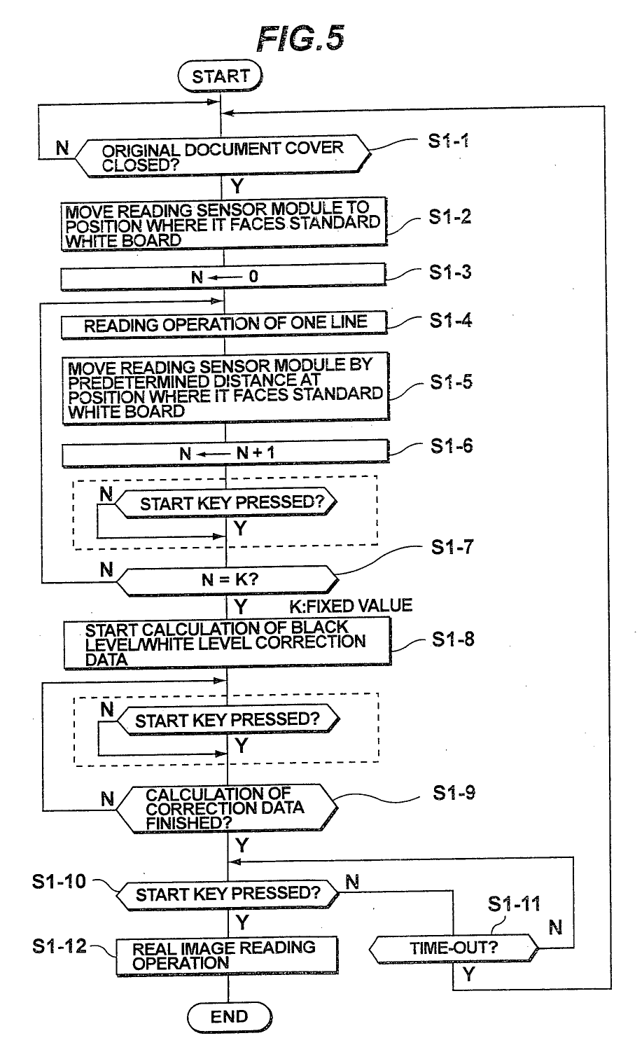

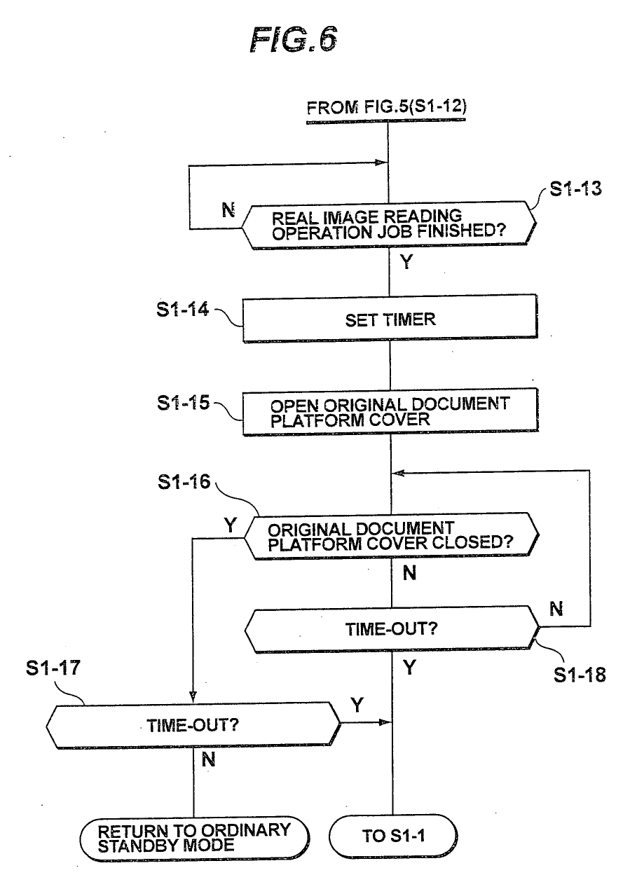

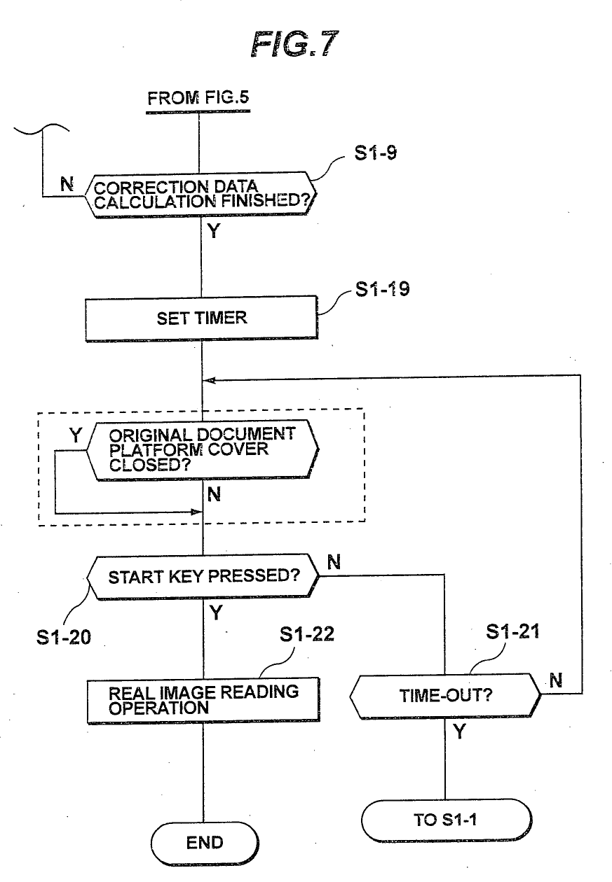

FIG. 5 is a flowchart for the image reading preparing operation.

The operator opens the original document cover 23 (FIG. 3) and sets the original document image 27 (FIG. 3) onto the platen glass 25, so that the image reading preparing means 16-2 (FIG. 1) starts the operation. The operation of the image reading preparing means 16-2 (FIG. 1) of the image reading apparatus according to the embodiment 1 will now be described in detail hereinbelow in accordance with the flowchart in order from step S1-1 to step S1-12.

Step S1-1:

When the operator closes the original document cover 23 (FIG. 3), the processing routine advances to the next step. At this time, since the magnet 29 (FIG. 3) approaches the magnetic sensor 21 (FIG. 3), the original document cover closing signal is sent from the original document platform cover opening/closure detecting unit 4 (FIG. 1) to the control unit 16 (FIG. 1).

Step S1-2:

When the control unit 16 (FIG. 1) receives the original document cover closing signal, it starts a series of image reading preparing operation (the operation of the-image reading preparing means 16-2 (FIG. 1)) (preparing operation starting means 16-3 (FIG. 1)). First, the original document platform motor 11 (FIG. 4) is driven, thereby moving the image reading sensor module 24 (FIG. 4) to the position where it faces the standard white board 32 (FIG. 4) (motor/lamp driving means 16-4) (FIG. 1).

Step S1-3:

The control unit 16 (FIG. 1) inputs “0” into a flag N of the data storing area 7-2 (FIG. 1) of the sub-storing unit 7 (counter means 16-5 (FIG. 1)). At this time, a trigger signal is sent to the timing signal generating unit 3 (FIG. 1).

Step S1-4:

The timing signal generating unit 3 (FIG. 1) forms an image reading timing signal synchronously with the received trigger signal and sends it to the image reading unit 1 (FIG. 1) and the A/D converting unit 2 (FIG. 1). When the image reading unit 1 (FIG. 1) receives the timing signal, it obtains the image information of the amount corresponding to one line (line which faces the standard white board 32 (FIG. 4)) and sends it to the A/D converting unit 2 (FIG. 1). The amplification factor used before the correction is maintained as an amplification factor of the amplifier 1-2 which is used here. The A/D converting unit 2 (FIG. 1) converts the analog image information of one line into the digital image information and sends it to the control unit 16 (FIG. 1). This image information is stored in a predetermined location in the data storing area 7-2 (FIG. 1) of the sub-storing unit 7 by the control unit 16 (FIG. 1).

Step S1-5:

The control unit 16 (FIG. 1) drives the original document platform motor 11 (FIG. 4), thereby moving the image reading sensor module 24 (FIG. 4) in the sub-scanning direction by a predetermined distance (for example, 1 line) in a range where it faces the standard white board 32 (FIG. 2) (a series of operations of the image reading preparing means 16-2 (FIG. 1) using the motor/lamp driving means 16-4)).

Step S1-6:

The control unit 16 (FIG. 1) increments the flag in the data storing area 7-2 (FIG. 1) of the sub-storing unit 7 (a series of operations of the image reading preparing means 16-2 (FIG. 1) using the counter means 16-5 (FIG. 1)). At this time, a trigger signal is sent to the timing signal generating unit 3 (FIG. 1).

Step S1-7:

If the flag in the data storing area 7-2 (FIG. 1) of the sub-storing unit 7 is equal to (N=K), the processing routine advances to the next step. If the flag does not reach K, the processing routine is returned to step S1-4 and the processes in steps S1-4 to S1-7 are repeated. A value of k is predetermined and has been installed in the program as one part of the image reading preparing means 16-2 (FIG. 1).

For a period of time in steps S1-6 to S1-7, even if the operator presses the start key, such an operation is ignored (a region surrounded by a broken line).

Step S1-8:

The control unit 16 (FIG. 1) reads out the image information of an amount corresponding to K lines from the data storing area 7-2 (FIG. 1) of the sub-storing unit 7 and calculates an average value. This average value is a value of the image information of the white level at the present image reading time. This value is stored as conversion information (volt) into the conversion information storing area 7-3 (FIG. 1) of the sub-storing unit 7 (FIG. 1). The image reading preparing means 16-2 (FIG. 1) compares the conversion information (volt) with the predetermined image information (volt) showing the reference white level reflection light and the dynamic range and increases or decreases the amplification factor of the amplifier 1-2 (FIG. 1) on the basis of the comparison result, thereby making the output voltage coincide with the predetermined image information (volt) showing the reference white level reflection light and the dynamic range. In this manner, the image reading preparation necessary to convert the reflection light intensity (lux) detected from the original document image set to the predetermined position on the original document platform into the image information (volt) is completed.

Step S1-9:

After the above-described processes are finished, the processing routine advances to the next step.

For a period of time which is required until the end of step S1-8, even if the operator presses the start key, such an operation is ignored (a region surrounded by a broken line).

Step S-10:

The control unit 16 (FIG. 1) enters the standby mode while waiting until the operator presses the start button 15-2 (FIG. 2).

Step S1-11:

The control unit 16 waits for a predetermined time (measured by the timer means 16-6 (FIG. 1)) until the operator presses the start button 15-2 (FIG. 2). If he does not press the start button, the processing routine is returned to step S1-1.

Step S1-12:

When the operator presses the start button 15-2 (FIG. 2) within the predetermined time (measured by the timer means 16-6 (FIG. 1)), the control unit 16 (FIG. 1) rotates the original document platform motor 11 (FIG. 4) and moves the image reading sensor module 24 (FIG. 4) to the position where it faces the front edge portion of the original document image 27 (FIG. 4). After that, the ordinary real image reading operation of the original document image (real image reading means 16-7 (FIG. 1)) is started.

FIG. 6 is a flowchart after the end of the real image reading operation.

The operation after the end of the real image reading operation of the image reading apparatus according to the embodiment 1 will now be described in detail hereinbelow in accordance with the flowchart in order from step S1-13 to step S1-18.

Step S1-13:

The control unit 16 (FIG. 1) enters the standby mode while waiting for the end of the real image reading operation.

Step S1-14:

When the real image reading operation is finished, the control unit 16 (FIG. 1) sets the timer to a predetermined time and activates it (timer means 16-6 (FIG. 1)).

Step S1-15:

The control unit 16 (FIG. 1) monitors the original document platform cover opening/closure detecting unit 4 (FIG. 1), detects that the operator opens the original document cover 23 (FIG. 2) in order to remove the original document image 27 (FIG. 2) on the platen glass 25 (FIG. 2), and advances to the next step.

Step S1-16:

The control unit 16 (FIG. 1) monitors the original document platform cover opening/closure detecting unit 4 (FIG. 1). When the control unit detects that the operator has closed the original document cover 23 (FIG. 2) within the predetermined time set in step S1-14, the processing routine advances to step S1-17. If it is not detected, step S1-18 follows.

Step S1-17:

When the reading operation of the original document image is completed and a time-out of the predetermined time set in step S1-14 occurs, the processing routine advances to the ordinary standby mode.

Step S1-18:

The control unit 16 (FIG. 1) monitors the original document platform cover opening/closure detecting unit 4 (FIG. 1). The control unit 16 (FIG. 1) enters the standby mode while waiting until the operator closes the original document cover 23 (FIG. 2). When the predetermined time set in step S1-14 has passed, the processing routine is returned to step S1-1 (FIG. 5) and the processes are executed again from the image reading preparing operation.

FIG. 7 is a flowchart after the end of the image reading preparing operation.

This diagram is a flowchart made by presuming the case where, in the flowchart for the image reading preparing operation of FIG. 5, after completion of the image reading preparation of the original document image in step S1-9, the original document image which has been set once by the operator is set again due to some reason. The processes will be described hereinbelow in order from step S1-19 to step S1-22.

Step S1-19:

After completion of the obverse surface image reading preparation in step S1-9, the control unit 16 (FIG. 1) sets the timer to a predetermined time and activates it (timer means 16-6 (FIG. 1)).

Step S1-20:

The control unit 16 (FIG. 1) enters the standby mode while waiting until the operator presses the start button 15-2 (FIG. 2).

For a period of time until the timer activated in step S1-19 times out, even if the operator opens or closes the original document platform cover, such an operation is ignored (a region surrounded by a broken line).

Step S1-21:

The control unit 16 waits for the predetermined time (measured by the timer means 16-6 (FIG. 1)) until the operator presses the start button 15-2 (FIG. 2). If he does not press the start button, the processing routine is returned to step S1-1.

Step S1-22:

The real image reading operation of the original document image is started.

As described above, in the image reading apparatus according to the embodiment 1, after the preparing operation starting means 16-3 (FIG. 1) received the original document platform cover closing signal from the original document platform cover opening/closure detecting unit 4 (FIG. 1), it starts the operation of the image reading preparing means 16-2. Therefore, such an effect that the influence of the disturbance light is eliminated is obtained. By activating the timer for allowing the opening/closure of the original document cover 23 (FIG. 2) to be ignored within the predetermined time after the end of the real image reading operation, even if the operator opens or closes the original document cover 23 (FIG. 2) and changes the original document within such a time, there is no need to newly make the image reading preparing means 16-2 operative, so that such an effect that a wasteful operating time can be shortened is obtained. Further, By activating the timer for allowing the opening/closure of the original document cover 23 (FIG. 2) to be ignored within the predetermined time after the end of the reading preparing operation, even if the operator opens or closes the original document cover 23 (FIG. 2) and sets the original document again within such a time, there is no need to newly make the image reading preparing means 16-2 operative, so that such an effect that a wasteful operating time can be shortened is obtained.

Although the invention has been described above on the assumption that all of the image processing means 16-1, image reading preparing means 16-2, preparing operation starting means 16-3, motor/lamp driving means 16-4, counter means 16-5, timer means 16-6, and real image reading means 16-7 are constructed by the control means which are formed by the method whereby the CPU executes the predetermined programs, the invention is not limited to such an example. That is, all or a part of those means can be also constructed by using dedicated electronic circuits.

### Embodiment 2

The embodiment is made by presuming the execution of the image reading preparing operation for both sides of the original document image.

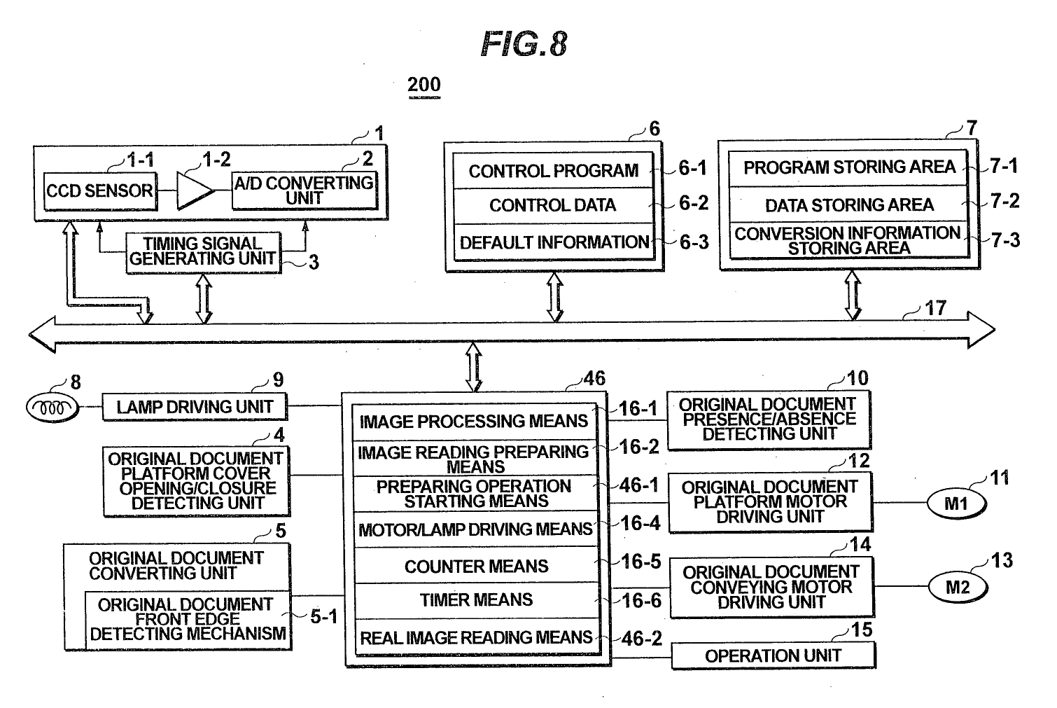

FIG. 8 is a constructional diagram of an image reading apparatus of the embodiment 2.

As shown in the diagram, an image reading apparatus 200 of the embodiment 2 has: the image reading unit 1; the AID converting unit 2; the timing signal generating unit 3; the original document platform cover opening/closure detecting unit 4; the original document conveying unit 5; the main storing unit 6; the sub-storing unit 7; the lamp 8; the lamp driving unit 9; the original document presence/absence detecting unit 10; the original document platform motor 11; the original document platform motor driving unit 12; the original document conveying motor 13; the original document conveying motor driving unit 14; the operation unit 15; and a control unit 46. Only portions different from those in the embodiment 1 will be described hereinbelow. The same or similar portions as those in the embodiment 1 are designated by the same reference numerals.

The control unit 46 is a CPU (central processing unit) for controlling the whole image reading apparatus 200. In the invention, particularly, the control unit 46 is a portion constructing control means such as image processing means 16-1, image reading preparing means 16-2, preparing operation starting means 46-1, motor/lamp driving means 16-4, counter means 16-5, timer means 16-6, real image reading means 46-2, and the like by executing predetermined programs.

The preparing operation starting means 46-1 is means for starting the operation of the image reading preparing means 16-2 after it received an original document front edge detection signal from the original document front edge detecting mechanism 5-1. This means is control means constructed by a method whereby the CPU reads out a predetermined control program which has previously been stored in the main storing unit 6, stores it into the program storing area 7-1 of the sub-storing unit 7, and executes it in accordance with a predetermined procedure.

The real image reading means 46-2 is means for stopping the image reading unit 1 at a predetermined position in the sub-scanning direction after the end of the image reading preparation and reading the real image of the original document image while moving the original document image in the sub-scanning direction line by line. This means is control means constructed by a method whereby the CPU reads out a predetermined control program which has previously been stored in the main storing unit 6, stores it into the program storing area 7-1 of the sub-storing unit 7, and executes it in accordance with a predetermined procedure.

The operation of the image reading apparatus of the embodiment 2 will now be described.

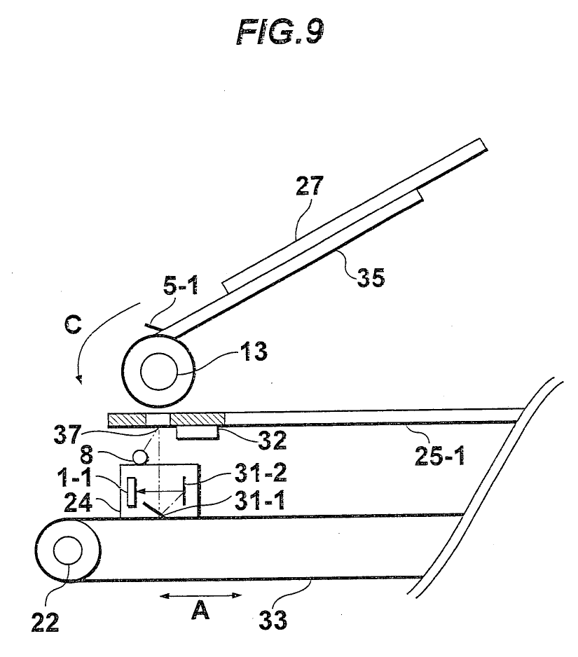

FIG. 9 is a function explanatory diagram (part 2) of an image reading unit.

This diagram is an explanatory diagram obtained by adding the original document conveying unit 5 (FIG. 1) to the function explanatory diagram (part 1) of the image reading unit of FIG. 4 which has already been described. In the diagram, reference numeral 27 denotes the original document image; 35 an original document conveying unit; 5-1 the original document front edge detecting mechanism to detect the front edge of the original document image 27; 13 the original document conveying motor; and 37 a window. The window 37 is a portion for stopping the image reading sensor module 24 to the position where it faces the window at the time of reading the real image, thereby enabling the original document image 27 to be read. Since other portions have already been described in conjunction with FIG. 4, their description is omitted here.

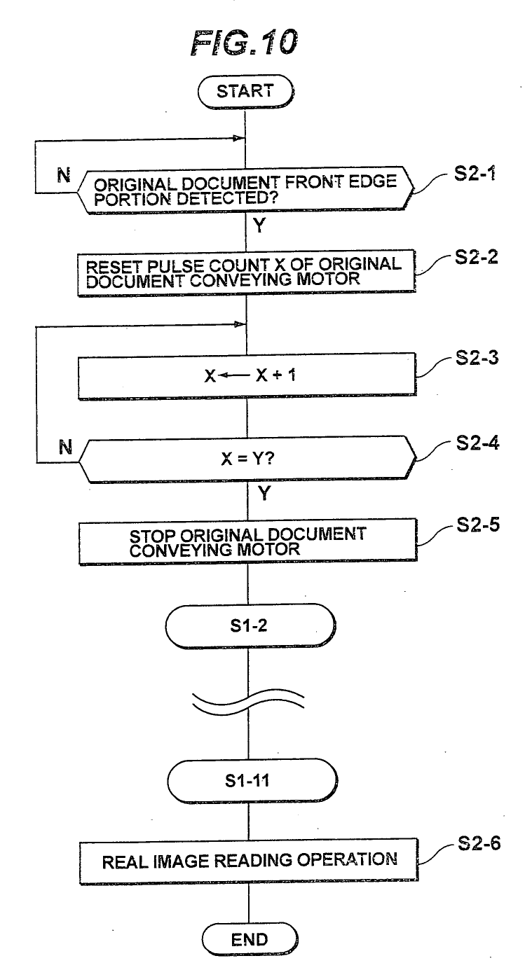

FIG. 10 is a flowchart for the reverse surface image reading preparing operation.

In FIG. 9, when the original document image 27 whose reverse surface image is to be read is put onto the original document conveying unit 35, the image reading preparing means 16-2 (FIG. 8) starts the operation. The reverse surface image reading preparing operation of the image reading apparatus according to the embodiment 2 will now be described in detail hereinbelow in accordance with the flowchart in order from step S2-1 to step S2-6. Since the obverse surface image reading preparing operation is substantially the same as the image reading preparing operation in the embodiment 1, its description is omitted.

Step S2-1:

When the original document front edge detecting mechanism 5-1 detects the front edge of the original document image 27 (FIG. 9) which is conveyed on the original document conveying unit 5 (FIG. 9) in the direction shown by an arrow C, an original document front edge detection signal is sent to the control unit 46 (FIG. 8).

Step S2-2:

When the control unit 16 (FIG. 8) receives the original document front edge detection signal, it starts a series of image reading preparing operation (the operation of the image reading preparing means 16-2 (FIG. 8)) (preparing operation starting means 46-3 (FIG. 8)). First, a pulse count X of the original document conveying motor 13 (FIG. 9) is reset (counter means 16-5 (FIG. 8)).

Step S2-3:

The control unit 16 (FIG. 8) increments the pulse count X (counter means 16-5 (FIG. 8)) while driving the original document platform motor 11 (FIG. 9) (the motor/lamp driving means 16-4 (FIG. 8)).

Step S2-4:

The control unit 16 (FIG. 8) continues to drive the original document platform motor 11 (FIG. 9) until the value of the pulse count X coincides with a predetermined value Y. When they coincide, the processing routine advances to the next step.

Step S2-5:

The control unit 16 (FIG. 8) stops the driving of the original document platform motor 11 (FIG. 9) and advances to step S1-2 in FIG. 6. After the processing routine advances to step S1-10 in FIG. 5, it advances to step S2-6. Since the contents of the processes of steps S1-2 to S1-10 in FIG. 5 have already been described in detail in the embodiment 1, their description is omitted here.

Step S2-6:

The control unit 16 (FIG. 8) stops the image reading sensor module 24 (FIG. 9) at the position of the window 37 (FIG. 9) in the sub-scanning direction and starts the real image reading operation while moving the original document image 27 (FIG. 9) in the direction shown by the arrow C (FIG. 9) line by line. The processing flow is finished.

As described above, in the image reading apparatus according to the embodiment 2, when the original document front edge detecting mechanism 5-1 (FIG. 9) detects the front edge of the original document image 27 (FIG. 9) which is conveyed on the original document conveying unit 5 (FIG. 9) in the direction of the arrow C, the original document front edge detection signal is sent to the control unit 46 (FIG. 8) and the operation of the image reading preparing means 16-2 is started. Therefore, in addition to the effect that the influence of the disturbance light is eliminated, since the original document conveying motor and the original document reading motor are not simultaneously driven, such an effect that a capacity of a power source of the whole apparatus can be set to a small value is obtained.

Although the invention has been described above on the assumption that all of the image processing means 16-1, image reading preparing means 16-2, preparing operation starting means 46-1, motor/lamp driving means 16-4, counter means 16-5, timer means 16-6, and real image reading means 46-2 are constructed by the control means which are formed by the method whereby the CPU executes the predetermined programs, the invention is not limited to such an example. That is, all or a part of those means can be also constructed by using dedicated electronic circuits.

Although the case where the invention is applied to the image reading apparatus has been described above, the invention is not limited to such an example. That is, the invention can be also applied to a hybrid apparatus (or multifunction apparatus) in which the image reading apparatus and the image forming apparatus are integrated, or the like.

The present invention is not limited to the foregoing embodiments but many modifications and variations are possible within the spirit and scope of the appended claims of the invention.

What is claimed is:

1. An image reading apparatus comprising:
a light source which irradiates an original document image set on a original document platform;
an image reading unit which detects reflection light of said original document image obtained by the irradiation of said light source and converts it into image information on the basis of predetermined conversion information; and
image reading preparing means which corrects said conversion information,
wherein said apparatus further has
a original document platform cover opening/closure detecting unit which detects opening/closure of an original document cover which covers said original document platform and
preparing operation starting means which starts the operation of said image reading preparing means after it receives an original document cover closing signal from said original document platform cover opening/closure detecting unit.

2. The image reading apparatus according to claim 1, wherein said image reading preparing means has a function of correcting said conversion information by using a light intensity level of at least either white level reflection light or black level reflection light detected by said image reading unit as a reference.

3. The image reading apparatus according to claim 2, further comprising timer means which ignores the operation of said original document platform cover opening/closure detecting unit within a predetermined time after the correction of said conversion information.

4. An image reading apparatus comprising:
a light source which irradiates a set original document image;
an image reading unit which detects reflection light of said original document image obtained by the irradiation of said light source and converts it into image information on the basis of predetermined conversion information; and
image reading preparing means which corrects said conversion information,
wherein said apparatus further has
an original document conveying unit which conveys said original document image to a predetermined position when the original document image is set and
preparing operation starting means which starts the operation of said image reading preparing means after said original document image is conveyed to said predetermined position.

5. The image reading apparatus according to claim 4, wherein said image reading preparing means has a function of correcting said conversion information by using a light intensity level of at least either white level reflection light or black level reflection light detected by said image reading unit as a reference.

6. The image reading apparatus according to claim 5, further comprising timer means which ignores the operation of said original document platform cover opening/closure detecting unit within a predetermined time after the correction of said conversion information.

7. An image reading apparatus comprising:
a light source which irradiates a set original document image;
an image reading unit which detects reflection light of said original document image obtained by the irradiation of said light source and converts it into image information on the basis of predetermined conversion information; and
image reading preparing means which corrects said conversion information,
wherein said apparatus further has
discriminating means which discriminates whether or not an original document has been set to a predetermined position and
preparing operation starting means which starts the operation of said image reading preparing means after it is determined that said original document has been set to said predetermined position.
